(19) United States
(12) Patent Application Publication
(10) Pub. No.: US 2008/0257731 A1
(43) Pub. Date: Oct. 23, 2008

(54) Heater Amperometric Sensor and Method for Operating the Same

(75) Inventors: Berndt Markus Cramer, Leonberg (DE); Bernd Schumann, Rutesheim (DE); Thorsten Ochs, Schwieberdingen (DE); Helge Schichlein, Stuttgart (DE); Sabine Thiemann-Handler, Stuttgart (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 11/884,580

(22) PCT Filed: Apr. 4, 2006
(86) PCT No.: PCT/EP06/61295

§ 371 Date: Aug. 16, 2007

(30) Foreign Application Priority Data
Apr. 21, 2005 (DE) 102005018438.3

(51) Int. Cl. G01N 27/30

(52) U.S. Cl. 204/425

(57) ABSTRACT

In order to operate an amperometric solid electrolyte sensor comprising a heating element which is separated from a sensor element by means of an electrical insulating layer, an electrical bias voltage is applied between the sensor element and the heater in such a way that the potential regions of the sensor element and the heater do not overlap.

### STATE OF THE ART

The invention at hand concerns an amperometric sensor on a solid electrolyte basis as well as a procedure for its operation according to the preambles of the respective independent claims.

The amperometric sensors which are concerned are deployed predominantly in electrochemical measuring probes and sensors, for example, to determine the oxygen content of gases and the lambda value of gas mixtures, especially those found in internal combustion engines. Such sensor elements, which are predominantly planar configured, have proven themselves in practice due to a simple and cost effective means of production, as they allow themselves to be comparatively simple to manufacture. Die and foil shaped solid electrolytes form the basis of the manufacturing process, i.e. ion conductive materials, for example, those from stabilized zirconium oxide.

Planar polarographic sensor elements (probes), which work according to the diffusion resistance principle, have achieved a particular importance for the sensors of concern here. Sensor elements of this kind are made known by the German patents DE-OS 35 43 759 and DE-OS 37 28 618 as well by the patents EP-A 0 142 992, EP-A 0 142 993, EP-A 0 148 622 and EP-A 0 194 082. In the case of such polarographic sensor elements, the diffusion current is measured with a constant voltage present at both electrodes of the sensor element; or the diffusion limit current is measured. This current is a function of the oxygen concentration in the exhaust gas resulting from combustion processes as long as the diffusion of the gas to a pumping electrode deployed in the sensor element determines the speed of the ongoing reaction. It is known that such polarographic sensor elements working according to the polarographic measuring principle are constructed in such a manner, that the anode as well as the cathode is exposed to the gas being measured, whereby the cathode has a diffusion barrier.

The operation of such amperometric sensors requires the setting of the temperature of the sensor element to a fixed value above 600° C. in a range of +/−50° C. For this purpose provision is made in a typical planar sensor construction for an internal heater consisting of a heating element 75 and a heater feeder 80.

The temperature of the sensor element can be influenced by regulation of the electrical heating output. The electrical heating output is normally adjusted by way of the familiar procedure of pulse amplitude modulation, whereby the heater is operated at a high potential voltage, i.e. in the off-state the entire heater lies at a positive battery voltage (11.4V . . . 13.8V) and in the on-state a heater connection is made to ground, so that a heating current flows from the positive to the negative heater terminal.

Such a heater also has the planar polarographic sensor element (probe) known previously from the German patent DE-OS 38 11 713, which has a pumping cell (A) and a diffusion unit (R) with a diffusion resistor in front of a pumping electrode of the pumping cell, whereby the diffusion resistor is formed by a porous sintered design body inserted into the non-sintered sensor element.

If a planar sensor element based on a solid electrolyte basis has an integrated heater, then this is embedded in an inherently known way in an insulating material, for example, Al₂O₃, embedded, whereby the heater and the insulating material are again embedded in the ionic conductive solid electrolyte material.

A disadvantage of such an embedding is that the danger exists for the electrical launching of the heater into the measuring cell(s), respectively “pumping cell(s)”, which are integrated in the sensor element. Reasons for this can be too small an insulation layer between the solid electrolyte and the heater, a defective insulation layer due to pinholes, tears or surface defects, or a limited insulation capability of the insulating material itself.

Such a sensor element proceeds, for example, from the German patent DE 43 43 089 A1. This sensor element has a heating ladder embedded in electrically insulating material, whereby especially a part of the electrically insulating material is separated galvanically by way of a cavity from the solid electrolyte substrate of the sensor element. The cavity or cavities allow a considerably improved electrical decoupling of the heating ladder from the measuring cell of the sensor element. The thickness of these cavities amounts to approximately 2 to 40 μm.

The heater as well as the electrical insulating material is for the most part embodied in thick film technology, i.e. they are printed as screen printing layers onto the ceramic electrolyte substrate (preferably Zr0₂). The heater print layer is produced thereby using platinum paste, which contains alkali ions as, for example, Ti, Ca, Na, K contingent upon the bulk technical manufacturing process according to the state of the art. The insulation paste and the ZrO₂ substrate can contain additionally further contaminations. During the sintering of the sensor element, these contaminations pass out of the heater layer by way of diffusion into the surrounding insulation layer. The contaminations now lead to an electrical launching onto the signals of the sensor electrodes during the operation of the heater.

A previously described heater arrangement according to the state of the art has, therefore, altogether the following disadvantages: the capacitive launching and the current leak, which are caused by the pulsed heating operation, lead to a measuring error in the sensor signal. This measuring error is all the greater, the worse the insulation effect of the insulation layer is. In order to increase the insulation resistance of the insulation layer by means of chemicals, the contamination concentrations in the heater paste, in the insulator paste and in the ZrO₂ substrate must be reduced. For this purpose, materials with a high degree of purity and manufacturing procedures which are attuned to them must be deployed, which causes higher costs per sensor element, respectively sensor.

### ADVANTAGES OF THE INVENTION

The idea behind the invention at hand is to increase the insulation resistance between the heater and the solid electrolyte, respectively the sensor element, by way of an electrical procedure, in order to supply a cost effective, easy to implement alternative or a supplementation to the aforementioned use of pure materials in the manufacturing process.

The electrical procedure according to the invention to increase the insulation resistance is based upon the impression of an electrical bias voltage between the heater and the sensor element, preferably between the heater and the electrode terminals of the sensor element.

In a preferable embodiment an electrical bias voltage is impressed between the ground of the electrical supply of the heater and the ground of a potentiostat serving to electrically supply the sensor element, so that the potentials of the electrodes in the sensor element and the potentials of the heater terminals can be displaced relative to each other to a freely selected value (FIG. 3).

The electrical bias voltage brings about a rise in the insulation resistance. A possible explanation for this is that the movable charge carriers, driven by the electrical field in the insulation layer, depending upon the polarity either move to the edge of the insulation layer or toward the heater, and in so doing, the contamination concentration in the insulation layer decreases (FIG. 2).

### DRAWINGS

The invention is subsequently described in more detail with reference to the drawings provided using the examples of embodiment, from which additional characteristics and advantages result, whereby identical or functionally equal characteristics in the figures of the drawings are in each case referenced with corresponding denotations.

The following are shown in detail in the drawing:

FIG. 1: a typical arrangement of an amperometric exhaust gas sensor according to the state of the art, in which the invention at hand is deployable;

FIG. 2: a schematic section enlargement of the exhaust gas sensor depicted in FIG. 1 for the illustration of charge carrier displacement to explain the increase of insulation resistance of the insulation layer;

FIG. 3: an electrical analogous circuit diagram for a sensor element of an exhaust gas sensor at hand and a heater with an insulation layer disposed between them according to the state of the art;

FIG. 4a: first typical potential positions of the sensor electrodes and heater according to the state of the art;

FIG. 4b: second typical potential positions of the sensor electrodes and heater according to the state of the art;

FIG. 5a: a potential range of the heating element reduced in size in an upward direction;

FIG. 5b: a potential range of the heating element reduced in size in a downward direction;

FIG. 6a: a voltage lift according to the invention enlarged in an upward direction;

FIG. 6b: a voltage lift according to the invention enlarged in a downward direction;

FIG. 7: a potential range according to the invention enlarged in an upward direction for the sensor electrodes in the case of the heating element feeders being designed asymmetrically;

FIG. 8a: an alternating operation implemented according to the invention of the exhaust gas sensor shown in FIG. 2, whereby the sensor is operated lean in an upward direction and rich in a downward direction; and

FIG. 8b: an alternating operation of the exhaust gas sensor shown in FIG. 2 implemented according to the invention, whereby the sensor is operated either at lambda=1 with OPE (outer pumping electrode) at the H (heater)+lean or with AR (air reference electrode) at the H (heater)+rich.

### DESCRIPTION OF THE EXAMPLES OF EMBODIMENT

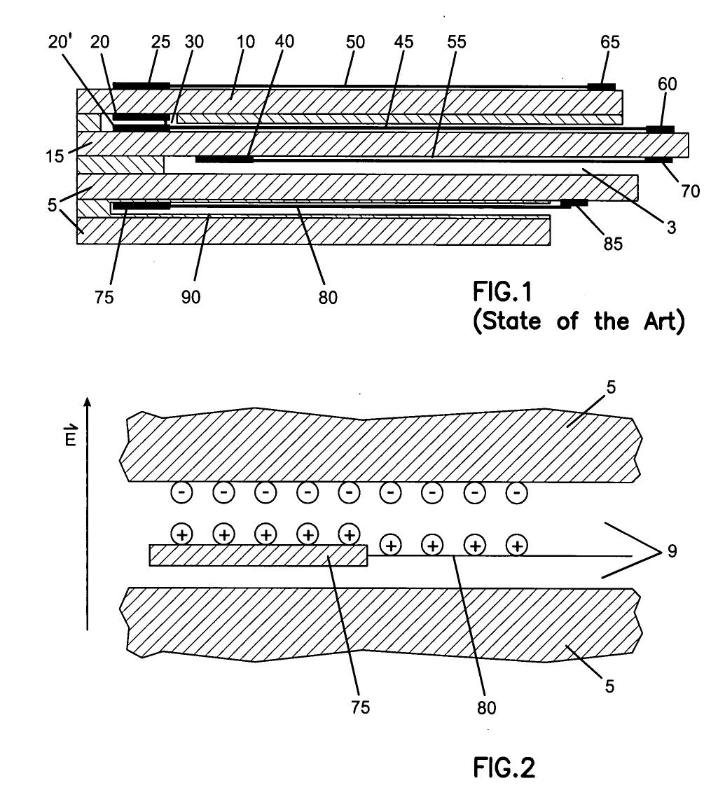

FIG. 1 shows simplified the arrangement of technical circuitry of an amperometric exhaust gas sensor. This includes a pumping cell 10 and a measuring cell 15, which are found on a substrate 5. The substrate 5 is primarily formed from zirconium oxide (ZrO₂). A two-parted inner pumping electrode (IPE) 20, 20′ as well as an outer pumping electrode (OPE) 25 are disposed at the pumping cell 10 in the sensory area of the exhaust gas sensor (in FIG. 1, the left end area). Especially the inner pumping electrode 20, 20′ is disposed in a cavity 30.

An air reference chamber 35 supplied with pure outside air, in which an air reference electrode (AR) 40 is disposed near the sensing area of the exhaust gas sensor, is positioned by design below the measuring cell 15. The air reference electrode 40 allows for reference measurements of the exhaust gas delivered to the cavity 30 with regard to the outside air. The sensor electrodes 20, 20′, 25 and 40 are connected by means of electrically conductive feeders 45-55 to the end of the exhaust gas sensor (on the right side of the depiction), which is turned away from the sensing area, with corresponding terminals 60-70.

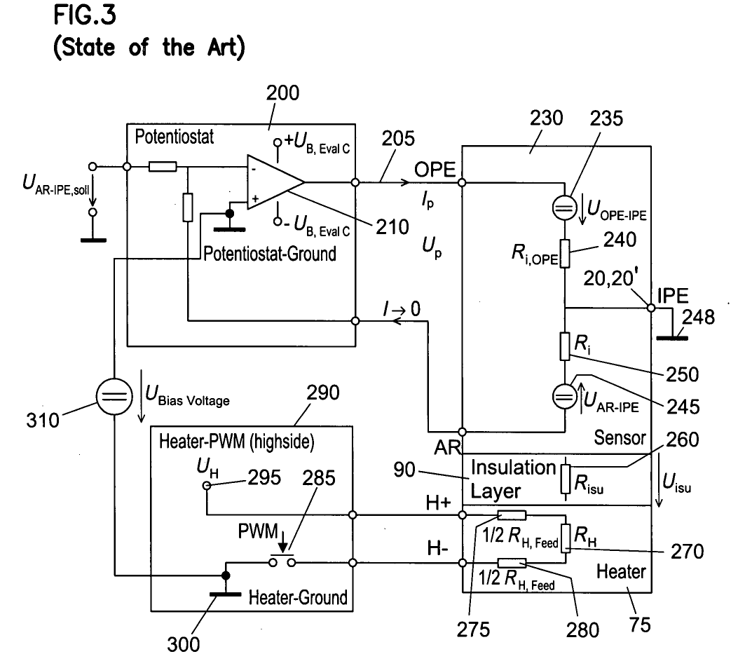

An existing heating element (Pt) 75 formed from a platinum electrode is embedded in the existing two ply substrate 5. The heating element 75 is likewise connected by means of feeders 80 made from platinum (Pt) to a terminal contact 85. It is to be noted, that only one of the feeders 80 can be seen in the side cross-section shown. The second feeder is located vertically to the plane of the paper and behind the feeder 80, which is depicted. It is to be further noted, that the exhaust gas sensor as well as the heating element 75 in FIG. 3 are only depicted by a simplified analogous circuit diagram for simplification of the depiction.

The heating element 75 as well as the feeders 80 are embedded in an existing insulation layer 90 formed out of aluminum oxide (Al₂O₃) and are, therefore, insulated electrically with regard to the measuring cell (sensor element). The insulation layer 90 is characterized by an insulation resistance Rᵢₛᵤ, which in an inherently known manner is dependent upon the geometry of the insulation layer 90 and the contamination concentration.

FIG. 2 shows a schematic sectional enlargement of the lower part of the exhaust gas sensor shown in FIG. 1 to illustrate the charge carrier displacement caused presumably as a result of the bias voltage according to the invention. By means of this displacement, the insulation resistance of the insulation layer 90, which is disposed between the substrate 5 of the sensor element and the heater 75, is increased by way of a purely electrical measure.

Due to the electrical field E charted in FIG. 2 (arrow indicates the field direction), which builds itself up due to the electrical bias voltage according to the invention, the positive charge carriers move increasingly in the direction of the heater 75-85, whereas the negative charge carriers move increasingly in the direction of the substrate 5. As previously mentioned, this charge carrier displacement leads to the increase of the insulation resistance of the insulation layer 90 with the advantages which were likewise previously stated.

The sensor electrodes are operated in an inherently known manner at one of the potentiostat evaluation circuits depicted in FIG. 3. The evaluation circuitry depicted on the left hand side of FIG. 3 comprises an inherently known potentiostat function 200 for the adjustment of a Nernst voltage U_{AR}_{_{—}}_{IPE} 245 between the air reference electrode AR 40 and the inner pumping electrode IPE 20, 20′. The IPE current 205 is measured as an actual pick-up signal by way of a corresponding, inherently known circuit, which is unspecified in FIG. 3. Such a circuit comprises, for example, a shunt resistance disposed between 200 and 210. The adjustment of the Nernst voltage 245 results in an inherently known manner (ref., for example, A. Bard, “Electrochemical Methods,” J. Wiley & Sons) by means of a potentiostat operation amplifier 210. The sensor is depicted on the right side of FIG. 3 in the form of an analogous circuit diagram 230, which comprises the sinking voltage U_{OPE-IPE} between the OPE 25 and the IPE 20, 20′, the internal resistance R_{i,OPE} 240 of the OPE 25 as well as the sinking voltage U_{AR-IPE} 245 between the AR 40 and the IPE 20, 20′ and the internal resistance R_{i,AR} of the AR 40. Moreover, the analogous circuit 230 encloses the insulation layer 90 in the form of its ohmic resistance Rᵢₛᵤ 260 and the resistance R_{H} 270 of the heating element 75 as well as the resistances 275, 280 of both heating element feeders 80, which in the example at hand are designed symmetrically and, therefore, in each case amount to the value ½ R_{H, Feed}.

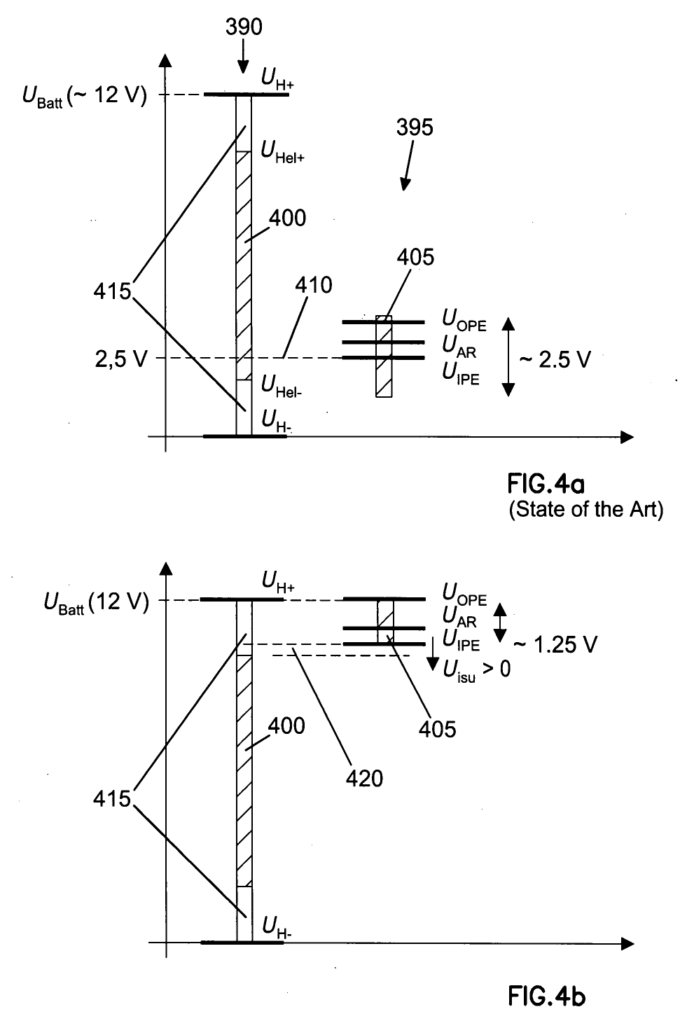

In this arrangement according to the state of the art, the IPE 20, 20′ is located at the potential of the potentiostat ground 248. The AR 40 lies, for example, in a typical operating state at +450 mV with regard to the IPE 20, 20′ and the OPE 25 at +1 V with regard to IPE 20, 20′. These potentials can alter depending upon the operating state of the sensor. The maximum potential range of the sensor electrodes 20, 20′, 25, 40 is depicted in FIG. 4a.

The voltage supply 290 of the heater 75-85 occurs by means of a highside field effect transistor 285 (“highside-FET”) and in fact between a heating supply voltage H+ 295 and a heater ground H-300. Hence, in the off-position all components 75-85 of the heater lie at the potential, which lies at H+ 295; while in the on-position the heating element terminal 85, which is charged with a negative voltage, lies at the potential of the heater ground H-300. The heating element 75 is located, as previously mentioned, in the sensor head in the area of the electrodes 20, 20′, 25 and 40 and possesses a higher electrical resistance than the heater feeders 80, so that the larger part of the heating output available is given off here. In the hot state, the ratio of R_{H} to R_{H,Feed}. is approximately 2:1, so that approximately ⅔ of the heating voltage drops across the heating element 75 in the sensor head. Accordingly, the entire heating voltage does not drop at the heating element 75, but only in the range between U_{Hel+} and U_{Hel-}, which is shaded with slanted lines in FIG. 4a.

In the circuit arrangement according to FIG. 3, a voltage source 310 to generate the electrical bias voltage is already included. The voltage source 310 is connected between the potentiostat ground 248 and the heater ground 300. The heater voltage 295 is drawn from the heater ground 300 and the supply voltage for the EvalC +/−U_{B,EvalC} is drawn from the potentiostat ground 248. The insulation bias voltage Uᵢₛᵤ can, therefore, be influenced across the insulation layer 90 by adjusting the voltage value U_{bias} at 310.

The diagram depicted in FIG. 4a shows in the area to the left 390 the typical potential positions of the heater 75-85, and in the area to the right 395 the typical potential positions for the sensor element (-electrodes) 20, 20′, 25, 40. The potential range of the heater 75-85 depicted in the area to the left 390 constitutes, as previously mentioned, the potential range 400 of the heating element 75 as well as the potential range 415 of the heater feeders 80, whereby the symmetrical case is shown in the example. In this case, both heater feeders 80 are designed electrically symmetrical. It can especially be understood from FIG. 4a, that in the potential ranges 410 above the dashed line, in which the potential range 400 of the heating element 75 and the potential range 405 of the sensor electrodes 20, 20′, 25, 40 overlap potential-wise (in the case at hand in the y-direction), and, thus, Uᵢₛᵤ=0 is valid. The charge carriers in the insulation layer 90 are free moving and can, thus, move in the manner depicted in FIG. 2.

In a potential arrangement according to the state of the art (FIG. 4a), the ground of the potentiostat and the IPE 20, 20′ are located at a value of 2.5 V above H—. Thus, the potential ranges of the heating element 75 and the sensor electrodes 20, 20′, 25, 40 overlap, so that no bias voltage occurs in the middle above the insulation layer, but on the contrary there are ranges in which the bias voltage is positive, zero or negative.

In an additional potential arrangement according to the state of the art in accordance with FIG. 4b, the outer pumping electrode OPE 25 is connected to the supply voltage of the heating element 75 as well as to the battery voltage, i.e. the correlation U_{OPE}=U_{H+}=U_{Batt} results. The potential position of the IPE 20, 20′ is closed-loop controlled relative to the OPE 25. The potential ranges of the heating element 75 and the sensor electrodes 20, 20′, 25, 40 do not overlap, so that an insulation bias voltage occurs. The disadvantage of this variation is that the operation of the exhaust gas sensor in a rich state requires that U_{IPE} lies above U_{OPE}, so that the IPE 20, 20′ will have to be operated at a potential above U_{Batt}, which is not possible during an operation which is purely battery supplied. For this reason, only a lean operation is possible with this potential position.

As previously mentioned, the invention at hand is based on the premise of assuring by a suitable selection of the manner of operation of the exhaust gas sensor, respectively of the heating element 75 disposed in it, that no overlapping of the potential ranges of the sensor electrodes 20, 20′, 25, 40 and of the heating element 75 occur, so that in no spatial area of the sensor head, the insulation bias voltage becomes zero, but is either only positive or only negative. Both potential ranges 400, 405 of the heating element 75 and the sensor electrodes 20, 20′, 25, 40 are separated from each other voltage-wise by the area denoted within the two dashed lines 420.

It proceeds from experiments that already for |Uᵢₛᵤ|>1 V a substantial increase in the insulation resistance Rᵢₛᵤ emerges due to the removal of the contamination concentrations in the insulation layer 90, which were mentioned at the beginning of the application.

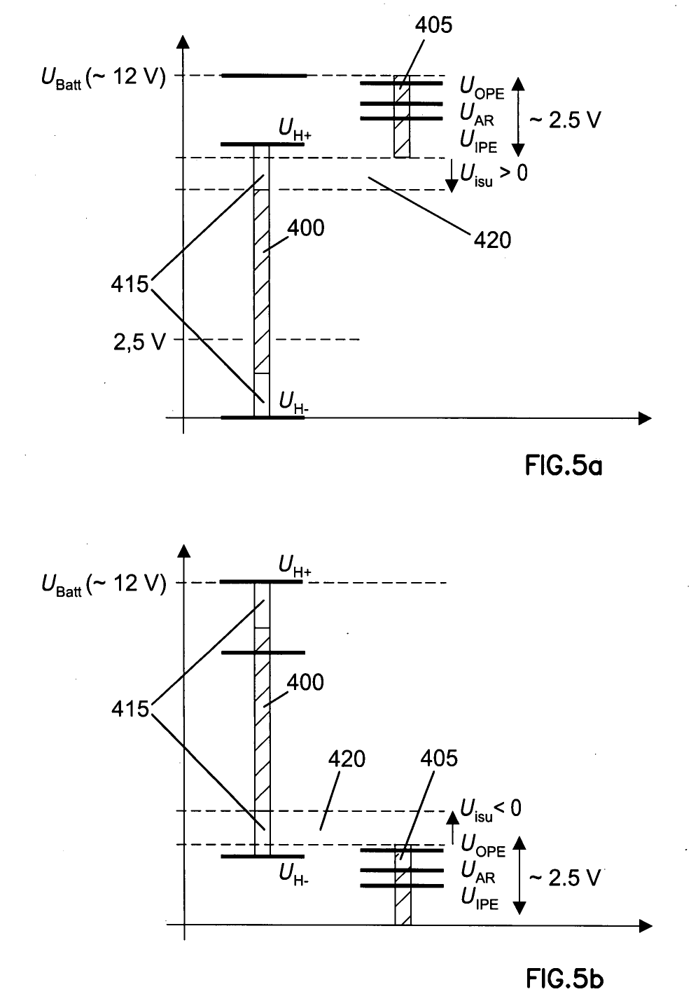

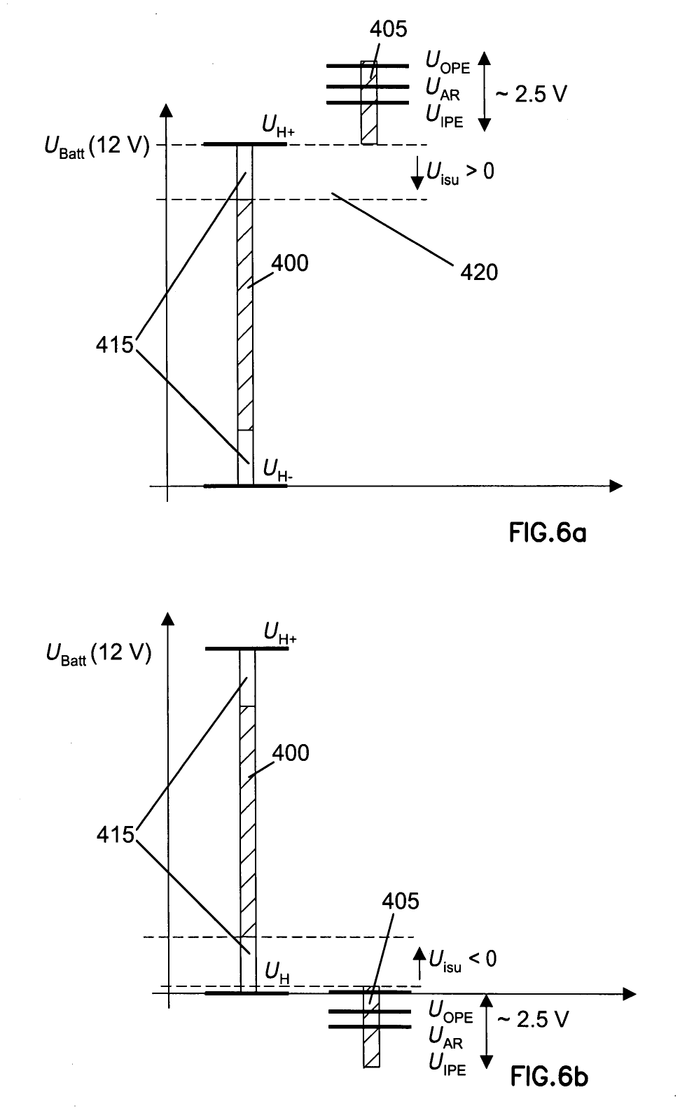

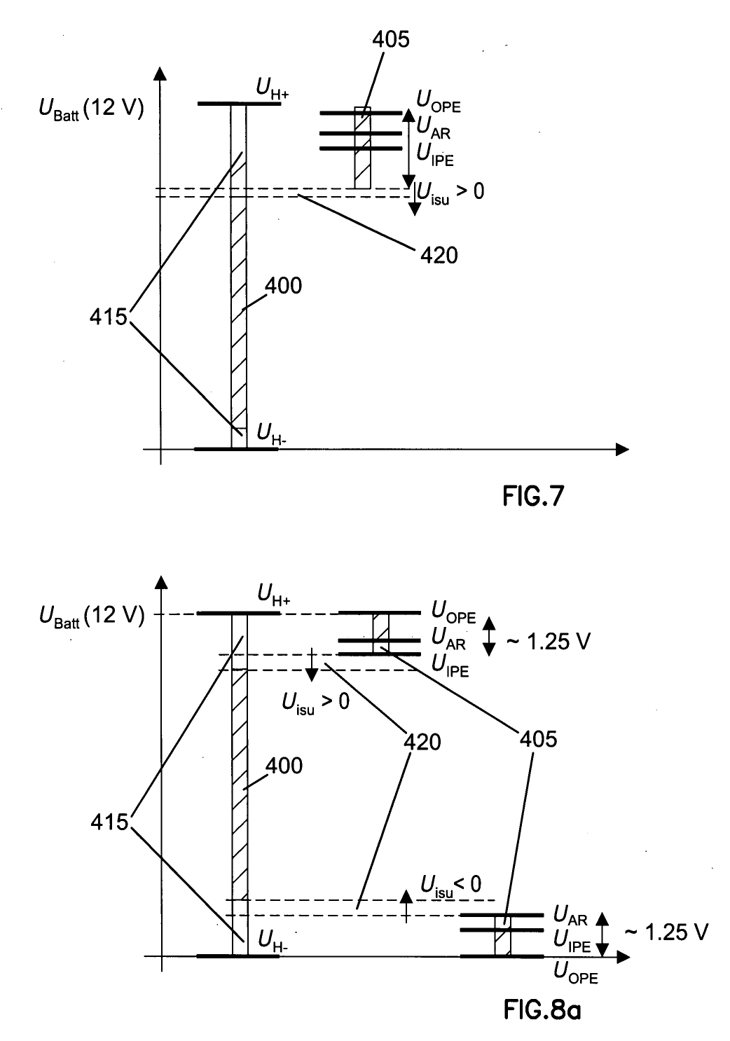

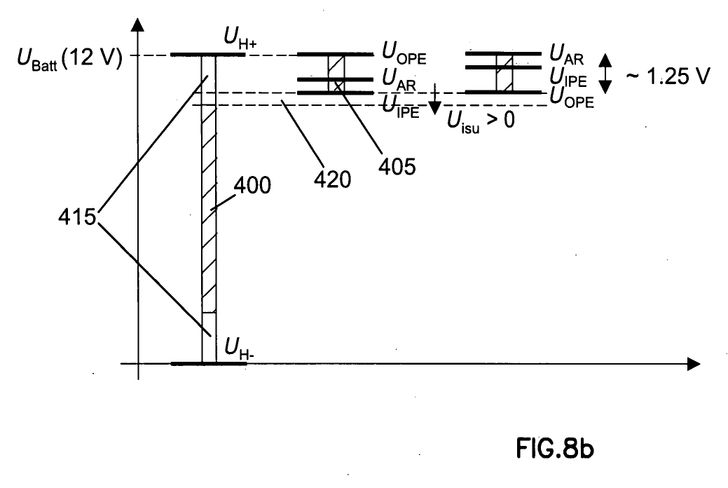

Subsequently several additional embodiment variations of the sensor according to the invention are described using FIGS. 5a to 8b. It is to be anticipated that the potential range of the heating element 75 in the examples of embodiment according to FIGS. 5a and 5b either reduce in size in a downward direction (FIG. 5a) or enlarge in size in an upward direction (FIG. 5b). In the examples of embodiment according to FIGS. 6a and 6b, the voltage lift either enlarges in an upward direction (FIG. 6a) or enlarges in a downward direction (FIG. 6b). In the example of embodiment according to FIG. 7, the electrical feeder of the heating element 75 is designed asymmetrically in order to maintain in the case at hand an enlarged potential range in an upward direction for the sensor electrodes 20, 20′, 25, 40. Finally the sensor according to the invention is operated in the alternating operation in the examples of embodiment according to the FIGS. 8a and 8b, whereby this operation is performed either lean in the upper potential range and at λ=1 or rich in the lower potential range.

In the example illustrated in FIG. 5a, the potential range 400 of the heating element 75 is enlarged at the upper potential end, in that the positive heating voltage is dropped under the battery voltage U_{Batt}. The potential U_{IPE} of the internal pumping electrode 20, 20′ is now set in this enlarged potential range. The potential ranges 400, 405 are, thereby, again separated from each other in the Figure at hand by the area 420 denoted between the two dashed lines, in which no overlapping of the potential ranges occurs. Due to this potential arrangement, it is especially guaranteed that the insulation bias voltage assumes a positive value. In so doing, a step with technical circuitry is, however, necessary. It is to be implemented in an inherently known manner, for example a DC-DC-converter, to generate a positive heating supply voltage with a value smaller than the battery voltage U_{Ban}. Altogether in this example of embodiment, the following results for the individual voltages:

U_{H+}=U_{Batt}−2.5 V, U_{Hel}+<U_{IPE}, U_{OPE}<U_{Batt}: Uᵢₛᵤ>0.

In the example of embodiment depicted in FIG. 5b, the potential range 400 of the heating element 75 is reduced in size in a downward direction. In so doing, an overlapping of the potential ranges 400, 405 is once again avoided within a range 420. Corresponding to the example depicted in FIG. 5a, the insulation bias voltage constantly assumes negative values, whereby the following is valid for the individual voltage values:

U_{OPE}<U_{H-}, U_{H+}=U_{Batt}: Uᵢₛᵤ<0.

In the example of embodiment shown in FIG. 6a, the IPE potential is set in a potential range above the positive heating voltage. In the area 420 located between the two dashed lines, an overlapping of the potential ranges 400, 405 of the heating element 75 and the sensor electrodes is also effectively avoided. As the insulation voltage Uᵢₛᵤ assumes the value of zero within the area set off by the dashed lines, a positive insulation bias voltage is constantly present here. In order to implement this potential arrangement, a step with technical circuitry to produce a voltage >U_{Batt} is once again required, for example, once again by means of a DC-DC converter. Alternatively the potential arrangement can be operated in an electrical distribution system with increased battery voltage (for example in a 42 V-electrical distribution system). In this case, a step with technical circuitry to generate a heater supply voltage below the battery voltage is necessary.

Similar to the example of embodiment shown in FIG. 6a, a voltage lift, which enlarges in a downward direction, is generated in FIG. 6b. In contrast to FIG. 6a, the insulation bias voltage Uᵢₛᵤ, however, constantly assumes negative values. To implement this, a step with technical circuitry, which is inherently known, is once again necessary to generate a voltage below the battery ground.

In the example of embodiment according to FIG. 7, the heating element feeders 80 are implemented asymmetrically above or below, so that the potential range 400 of the heating element 75 no longer comes to lie in the middle of the potential range 400, 415 of the entire heater (including the feeders), i.e. the two potential ranges 415 of the heating element feeders 80 are likewise designed asymmetrically in this example (larger above than below). FIG. 7 illustrates only the first of these two cases, i.e. the second one with a configuration, which becomes more asymmetrical in a downward direction, is not shown here. Due to this step, a larger existing potential range 405 (namely approximately 2.5 V), in which a positive insulation bias voltage Uᵢₛᵤ>0 occurs, is made available to the sensor electrodes 20, 20′, 25, 40 at the upper (respectively lower) end of the potential range 400 of the heating element 75. Within the area 420, in which no overlapping of the two potential ranges 400 and 405 takes place, Uᵢₛᵤ=0 is valid. It is to be noted, that the insulation bias voltage Uᵢₛᵤ is either positive (FIG. 7) or negative (no figure) depending upon the embodiment of the asymmetrical heater 75-85.

In the example of embodiment shown in FIG. 8a, the sensor is operated in an alternating operation, namely top and bottom for lean and rich. In the potential arrangement shown there, the potentiostat ground and with it also both potential ranges 405 of the sensor electrodes at hand is set by means of a suitable closed-loop control of the bias voltage in the upper potential range 415 of the heating element feeders 80, when a lean operation is present and at Lambda=1, and in the lower potential range 415 of the feeders, when a rich operation is present. For both potential ranges 405, an overlapping with the potential range 400 within both ranges 420 is effectively avoided. In the lean operation the insulation bias voltage Uᵢₛᵤ is constantly positive and in the rich operation constantly negative. The insulation bias voltage changes here at a lambda=1−trial and most certainly the sign in front of the value, so that a somewhat reduced insulating effect is to be taken into account.

In the example of embodiment shown in FIG. 8b, the outer pumping electrode (OPE) is connected to the electrical heating supply in the lean operation at lambda=1, and in the rich operation, the air reference electrode (AR) 40 is connected to the heating supply. The insulation bias voltage Uᵢₛᵤ assumes both in the rich operation as well as in the lean operation positive values, i.e. Uᵢₛᵤ>0. Within the area 420, in which once again no overlapping of the potential ranges 400 and 405 occur, the insulation bias voltage amounts to Uᵢₛᵤ=0. Once again an inherently known step with technical circuitry is required for the switching of the OPE 25 and of the AR 40 to the heater supply.

1. A method of operating an amperometric solid electrolyte sensor with a sensor element and a heater, that includes at least one heating element and at least two heating element feeders separated from the sensor element by way of an electrical insulation layer, the method comprising:
impressing an electrical bias voltage in such a manner between the sensor element and the heater, that potential ranges of the sensor element and the heater do not overlap.

2. A method according to claim 1, where in the sensor element has electrode terminals that are electrically supplied, wherein impressing includes impressing the electrical bias voltage between the heater and the electrode terminals of the sensor element.

3. A method according to claim 2, wherein the sensor element is operated with a potentiostat evaluation circuitry, wherein impressing includes impressing the electrical bias voltage between a ground and the electrical supply of the heater and a ground of the potentiostat evaluation circuitry.

4. A method according to claim 3, wherein the sensor element is operated in an alternating operation whereby the ground of the potentiostat evaluation circuitry is set by a closed-loop control of the bias voltage in an upper potential range of heating element feeders during a lean operation and at a lambda value of 1 and in a lower potential range of the heating element feeders during a rich operation.

5. A method according to claim 1, wherein the sensor element has an inner and an outer pumping electrode, and the potential range of the heating element enlarges at the upper potential end by sinking a positive supply voltage of the heater under a battery voltage, and in that a potential of the inner pumping electrode is set in this enlarged potential range.

6. A method according to claim 5, wherein the potential range of the inner pumping electrode is set in a potential range above or below the positive supply voltage of the heater.

7. A method according to claim 1, wherein the potential range of the heating element is reduced in size in a downward direction.

8. A method according to claim 1, wherein at least two heating element feeders are asymmetrically implemented on the top or bottom, so that the potential range of the heating element no longer comes to lie in the middle of the potential range of the heater.

9. (canceled)

10. An amperometric solid electrolyte sensor comprising a sensor element and a heater having at least one heating element and at least two heating element feeders separated from the sensor element by an electrical insulation layer, and a first meant voltage supplier to supply an electrical bias voltage between the sensor element and the heater.

11. A solid electrolyte sensor according to claim 10, further comprising a second voltage supplier to provide a positive supply voltage to the heater with a value smaller than the battery voltage.

12. A solid electrolyte according to claim 10, wherein the second voltage supplier is a DC-DC-converter.

13. A solid electrolyte sensor according to claim 10, wherein the first and second voltage supplier are the same device.
